(19) United States
(12) Patent Application Publication
(10) Pub. No.: US 2007/0140455 A1
(43) Pub. Date: Jun. 21, 2007

(54) Media gateway and next generation network system

(76) Inventor: Bo Zhao, Shenzhen (CN)

Correspondence Address: HARNESS, DICKEY & PIERCE, P.L.C., P.O. BOX 828, BLOOMFIELD HILLS, MI, 48303, US

(21) Appl. No.: 11/642,949

(22) Filed: Dec. 20, 2006

(30) Foreign Application Priority Data
Dec. 20, 2005 (CN) 200510132648.5

(51) Int. Cl. H04M 3/00

(52) U.S. Cl. 379/198

(57) ABSTRACT

A media gateway and a communication system including the media gateway are disclosed. The media gateway includes at least one remote module and a central module. The at least one remote module is disposed in proximity to a private branch exchange (PBX) for converting format of a media stream and a signaling stream. The central module is disposed in proximity to a packet switched network side and communicates with the at least one remote module for transporting the media stream and the signaling stream between the at least one remote module and the packet switched network based on a control signal from a media gateway controller (MGC).

### CROSS-REFERENCE TO RELATED APPLICATIONS

This application claims the benefit of Chinese Patent Application No. 200510132648.5, filed on Dec. 20, 2005. The disclosure of the above application is incorporated herein by reference.

### FIELD

The present disclosure relates to next generation network techniques, and more particularly to a media gateway applied in the next generation network.

### BACKGROUND

The statements in this section merely provide background information related to the present disclosure and may not constitute prior art.

As current development of public switched telephone network (PSTN) and data network has been becoming stable and mature, people begin to give attention to the next generation network (NGN). The NGN is proposed with the evolution from bearing network to packet network, which adopts IP network as a bearing network. The key technology of NGN is soft switching, which may combine services, separate the access portion and the control portion of PSTN, and at the same time, provide interfaces for application and development, so that various flexible services may be developed to meet requirements of telecommunication market.

It is necessary that NGN should be subject to a gradually developing process from coexisting with PSTN to substituting for PSTN. During transition from PSTN to NGN, it is usually required for prior private branch exchange (PBX) devices of users access the NGN.

As shown in FIG. 1, when users access to the NGN, it may generally dispose a media gateway (MG) between the PBX connecting to the users and the NGN. The media gateway may provide a downlink trunk interface (usually a E1/T1 interface) for interconnecting with the PBX (which is usually accessed by E1/T1 interface, and supports PRI (primary rate interface) signaling or R2 channel-associated signaling). Since the above media gateway is distinct from the conventional access media gateway at downlink user interface, it can be called PBX-AG (Access Gateway), which acts as an important component in NGN. To some extent, the association of the media gateway and the soft switching system will determine the network architecture of NGN.

However, the PBX at user side usually has dispersed sites, yet has small capacity. Typically, each site gives out one or two E1/T1 trunk uplink(s). In order to reduce the operating cost, operator usually may not desire to maintain an additional TDM (Time Division Multiplex) transport network, but E1/T1 line cannot be extended too long, therefore, PBX-AG only can be disposed at the place where the PBX at user side locates. As a result, the PBX-AGs are arranged dispersedly, and their capacity is small, yet the required number of PBX-AGs is large (each PBX-AG accesses a few PBXs, while cannot be integrated).

### SUMMARY

According to an aspect of the present invention, there is provided a media gateway including at least one remote module, each disposed in proximity to a private branch exchange (PBX) for converting format of a media stream and a signaling stream; and a central module, disposed in proximity to a packet switched network side and communicating with the at least one remote module for transporting the media stream and the signaling stream between each the at least one remote module and the packet switched network based on a control signaling from a media gateway controller (MGC).

In another aspect, the present invention provides a communication system including at least one private branch exchange (PBX); a media gateway controller (MGC); and a media gateway comprising at least one remote module, each disposed in proximity to one of the at least one PBX for converting format of a media stream and a signaling stream; and a central module disposed in proximity to a packet switched network and communicating with the at least one remote module for transporting the media stream and the signaling stream in IP format between the at least one remote module and the packet switched network based on a control signaling from the MGC, wherein the at least one PBX communicating with the packet switched network through the media gateway based on a control signaling from the MGC.

The present invention is applicable to PBXs that are disposed dispersedly and have a large accessing amount but small capacity. Especially, it is applicable to the case that there is no TDM connection between the central computer room and the location of the PBXs, while the PBX-AGs have to be disposed dispersedly.

According to the present invention, the central module integrates the remote modules together, and the MGC controls only one media gateway, thereby effectively decreasing the requirement for performance of MGC as compared to the case that each PBX requires one media gateway. Also, according to the present invention, the central module and the remote modules act as a single device, and maintainers may manage a single media gateway, which simplifies maintenance and management. Additionally, the present invention simplifies the function of the remote modules, which may lower the failure rate, and at the same time, simplify the failure recovery operation (by replacing the modules) to effectively reduce the cost of maintenance and management.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram showing the connection of users and NGN;

FIG. 2 is a schematic diagram showing the connection of users and NGN by a media gateway according to the present invention;

FIG. 3 is a schematic diagram showing architecture of a remote module of a media gateway according to the present invention;

FIG. 4 is a schematic diagram showing architecture of a central module of a media gateway according to the present invention;

FIG. 5 schematically shows the operation of the media gateway according to the present invention;

FIG. 6 is a diagram showing the operation of the media gateway according to the present invention;

FIG. 7 is a diagram showing the operation of maintenance and management of the media gateway according to the present invention.

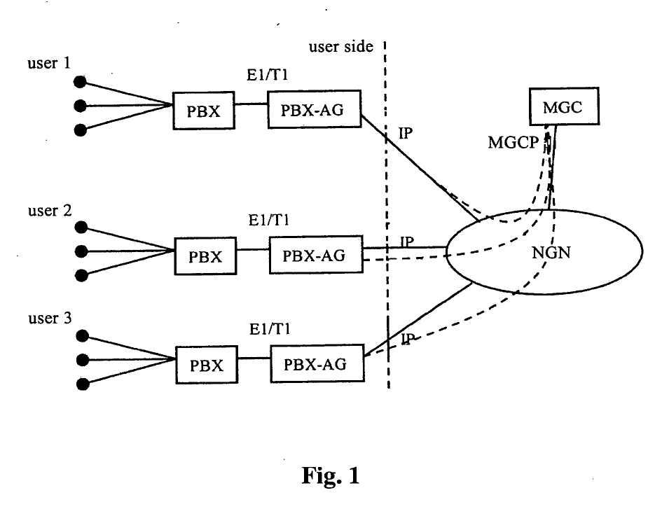

### DETAILED DESCRIPTION

The following description is merely exemplary in nature and is not intended to limit the present disclosure, application, or uses. It should be understood that throughout the drawings, corresponding reference numerals indicate like or corresponding parts and features.

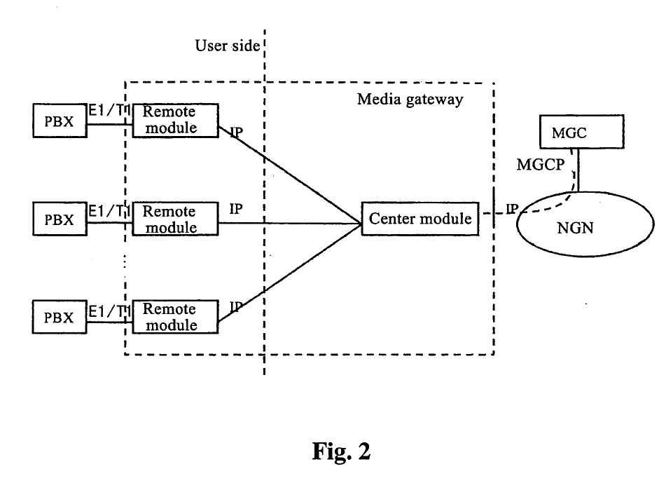

FIG. 2 is a schematic diagram showing the connection of users and NGN by a media gateway according to the present invention. As shown in FIG. 2, the media gateway includes a central module and one or more remote modules. The central module and the remote modules may be disposed in different locations and connected via IP network. Generally, the central module may be disposed in a central computer room, and access the NGN via IP under control of a Media Gateway controller (MGC); while the remote modules may be disposed in a location where a private branch exchange (PBX) at user side locates, and connected to the respective PBX via E1/T1.

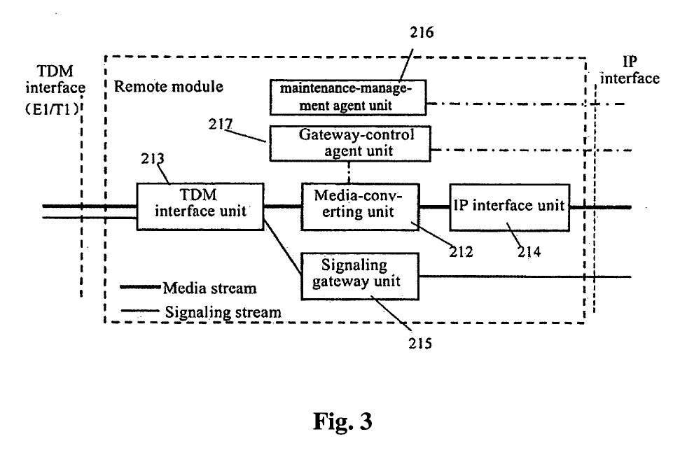

FIG. 3 is a schematic diagram showing the architecture of a remote module of a media gateway according to the present invention, in which a bold line represents media stream, a fine line represents signaling stream, and a dashdotted line represents control and maintenance-management stream. As shown in FIG. 3, the remote module may include a Time Division Multiplex (TDM) interface unit 213, a media-converting unit 212, an IP interface unit 214, and a signaling gateway unit 215. The TDM interface unit 213 may provide E1/T1 interfaces and interconnect with the respective PBX. The media-converting unit 212 may convert the bearing media stream between T1/E1 bearing format and IP bearing format. The IP interface unit 214 provides an IP interface, and is able to receive or transmit IP packets of the bearing media stream. The signaling gateway unit 215 converts PBX signaling (such as DSS1 signaling and R2 signaling) carried on the TDM trunk into signaling in IP format, or converts signaling in IP format from the central module into PBX signaling carried on the TDM trunk. The remote module further includes a simple gateway-control agent unit 217 for controlling the “on” and “off” statuses of media channels according to instructions from the central module, and a simple maintenance-management agent unit 216 for configuring parameters and reporting operating status of the media channels according to instructions from the central module.

The media channel is constituted by a timeslot for services over the TDM interface unit 213, a DSP (Digital Signal Processor) channel over the media-converting unit 212, and an IP endpoint (identified by an IP address and an IP port number) over the IP interface unit 214, and is automatically formed in certain rule after the remote modules are power-on. For example, a first timeslot, a first DSP channel, and a first IP port number over the IP interface form the first media channel, and so on. This is implemented by software encoding other than instructions from the central module. The central module may simply instruct to turn on or off the media channels through the gateway-control agent unit 217.

Likewise, after the remote modules are power-on, the signaling gateway unit 215 may also automatically generate a signaling channel. One end of the signaling channel is a TDM signaling link interface (such as PRI) for bearing 16 timeslots of DSS1 signaling, and the other end of the signaling channel is an IP signaling link (for example, IUA (ISDN Q.921-User Adaptation Layer) link for bearing DSS1 signaling). The signaling channel operates all the time.

The central module may make simple configuration for the parameters of the remote modules via maintenance-management agent unit 216, for example, configuration for the addresses of IP interfaces. The remote modules may report the status of media channels via maintenance-management agent unit 216.

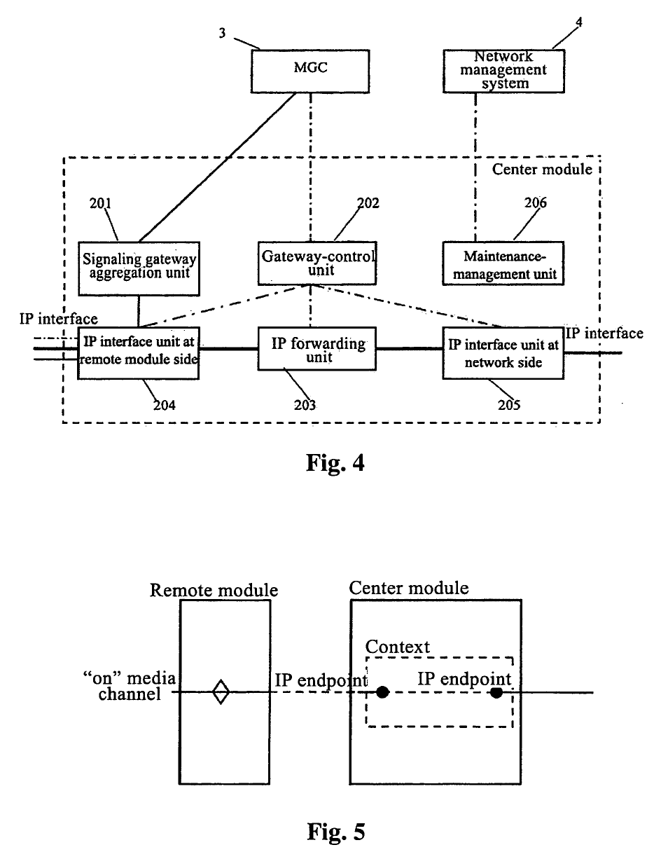

FIG. 4 is a schematic diagram showing the architecture of the central module, in which a bold line represents media stream, a fine line represents signaling stream, and a dashdotted line represents control and maintenance-management stream. As shown in FIG. 4, the central module includes a gateway-control unit 202, an IP interface unit at the remote module side 204, an IP interface unit at the network side 205, an IP forwarding unit 203, a signaling gateway aggregation unit 201 and a maintenance-management unit 206.

The gateway-control unit 202 is controlled by a media gateway controller (MGC) 3 under gateway control protocol (such as H.248 protocol, Media Gateway Control Protocol (MGCP) and other private protocols). Specifically, the control command of MGC 3 should be mapped into on/off command for media channels of the remote modules. The IP interface unit at the remote module side 204 receives and transmits IP media stream from the remote modules. The IP interface unit at the network side 205 receives and transmits IP media stream from the network side. The IP forwarding unit 203 forwards media streams between the IP interface unit at the remote module side 204 and the IP interface unit at the network side 205, and at the same time converts IP addresses and port numbers. In fact, at the remote modules side, upon the remote modules and media channels thereon are determined, the home or peer IP address/IP port number are already determined. At the network side, the home IP address and port number are generally dynamically selected, while the peer IP address and port number need to be informed by the MGC 3. As a result, converting is often required, if necessary, it may convert encoding and decoding format or copy media streams (monitoring function) at the same time.

The signaling gateway aggregation unit 201 aggregates a plurality of signaling links of the remote modules into a single signaling link, and sends it to the MGC. In the opposite direction, it demultiplexes the signaling link into a plurality of signaling links and sends the signaling links to respective remote module.

The maintenance-management unit 206 is used to maintain and manage the entire media gateway, including maintaining and managing parameter configuration, maintenance and management operation, report of status of the apparatuses, and the like. The maintenance-management unit detects the status of the remote modules via Heartbeat Protocol (for example, BFD (Bi-direction Forwarding Detection) or other private heartbeat protocol) and if the status of the remote modules is normal, the remote modules are maintained and managed via maintenance-management unit 206.

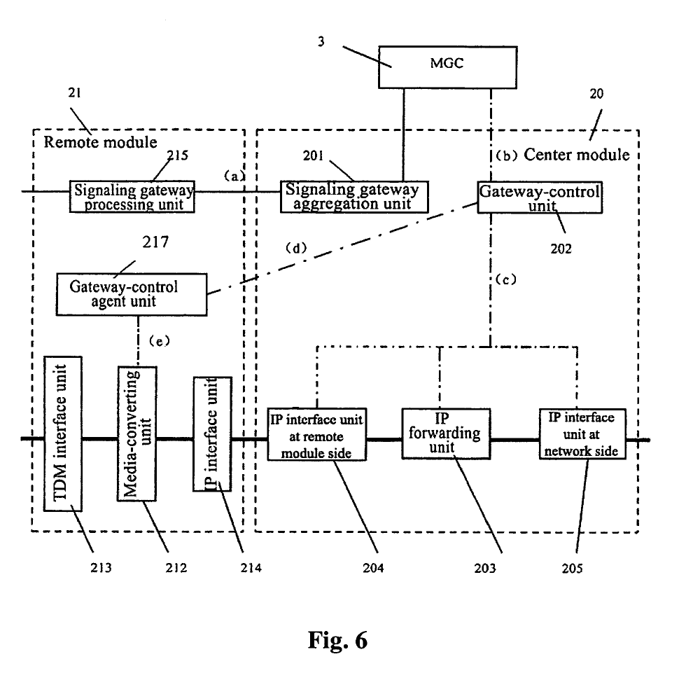

FIG. 5 schematically shows the operation of the media gateway according to the present invention, and FIG. 6 is a diagram showing the operation of the media gateway according to the present invention, in which a bold line represents media stream, a fine line represents signaling stream, and a dashdotted line represents control and maintenance-management stream. As shown in FIG. 6, without limitations, only one remote module is exemplarily illustrated. During a typical calling (H.248 gateway-control protocol as an example), the PBX may firstly convert PBX signaling carried over TDM trunk into signaling in IP format via signaling gateway unit 215 in the remote module 21, transmits the converted signaling to the signaling gateway aggregation unit 201 of the central module 20 via IP network (i.e., (a) in FIG. 6), and then sends the signaling to the MGC 3 to initiate a calling. If there are plural remote modules, the signaling gateway aggregation unit 201 may aggregate a plurality of signaling links of the remote modules into a single signaling link and send the single signaling link to the MGC 3, or oppositely, it demultiplexes a signaling link into a plurality of signaling links and sends the signaling links to the remote modules. When the calling is accepted, the MGC 3 requires that the media gateway connect the trunk at the TDM side and the endpoint at the IP side via the gateway-control unit 202 of the central module 20, where the gateway-control unit 202 is controlled by the MGC 3 via H.248 gateway control protocol (i.e., (b) in FIG. 6). As shown, first, establish the forwarding relation (see FIG. 5) of two IP endpoints (one is at the remote module side, the other is at the network side) at the central module 20; that is, forward the media stream by the IP forwarding unit 203 between the IP interface unit at the remote module side 204 and the IP interface unit at the network side 205, and convert IP addresses and port numbers (i.e., (c) in FIG. 6); and then the gateway-control unit 202 maps the control command of MGC 3 into on/off command for media channels of the remote modules, i.e., on/off command of a DSP channel over the media-converting unit 212 (i.e., (d) in FIG. 6), and informs the gateway-control agent unit 217 of the remote module 21 to turn on the media channel corresponding to the trunk at TDM side (i.e., (e) in FIG. 6), so that the media stream in T1/E1 bearing format in the TDM interface unit 213 linking to the PBX, or the media stream in IP bearing format in the IP interface unit 214 of the remote module 21, is converted between T1/E1 bearing format and IP bearing format by the media-converting unit 212 and then is transmitted. Accordingly, one calling may be normally established, and PBX users can communicate with NGN users.

In the media gateway of the present invention, the remote modules are simplified as much as possible to simply have minimal functions such as accessing PBXs and TDM-IP media conversion under control of the central module, while other functions are detracted which will be carried out by the central module. During operating process, the remote modules turn on and/or off the media channel, while the central module carries out the remaining processes.

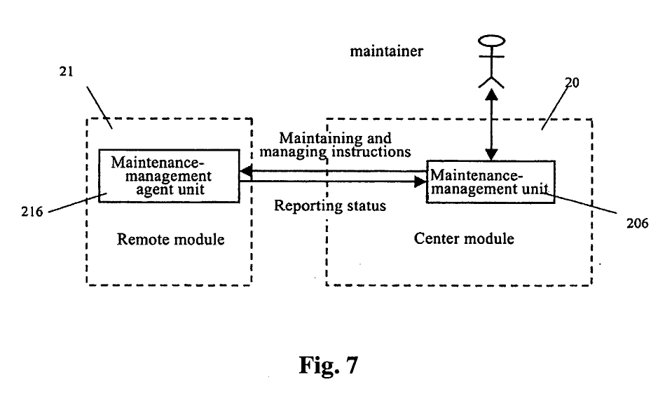

When the remote module fails or requires maintenance, for example, the maintainer desires to check the current operating status of the apparatuses. As shown in FIG. 7, the maintainer may send maintenance and management command to the maintenance-management unit 206 of the central module. If the remote module 21 is involved, the maintenance-management unit 206 will initiatively interact with the maintenance-management agent unit 216 of the remote modules, so as to complete the execution of maintaining and managing operations. The maintenance-management agent unit 216 of the remote modules 21 also will initiatively, or by the requirement of the maintenance-management unit 206 of the central module 20, report the status information.

If there are plural remote modules, during maintenance the central module separately manages each remote module, and the managing manner is the same as shown in FIG. 7.

In another aspect, the PBX at user side, the above-mentioned media gateway, and a media gateway controller may form an NGN communication system, in which the PBX accesses to the NGN via IP under control of the MGC through the media gateway.

Although illustrative embodiments have been described herein with reference to the accompanying drawings, it should be understood by those skilled in the art that the present invention is not limited to those preferred embodiments, and that various changes and modifications can be made therein without departing from the spirit and the scope of the invention. Thus, it is intended that the present invention covers the modifications and variations of this invention provided they come within the scope of the appended claims and their equivalents.

What is claimed is:

1. A media gateway comprising:
at least one remote module, each disposed in proximity to a private branch exchange (PBX) for converting format of a media stream and a signaling stream; and
a central module disposed in proximity to a packet switched network and communicating with said at least one remote module for transporting the media stream and the signaling stream between each said at least one remote module and the packet switched network based on a control signaling from a media gateway controller (MGC).

2. The media gateway according to claim 1, wherein said central module is further configured for controlling said at least one remote module to turn on and off media channels and configuring said at least one remote module.

3. The media gateway according to claim 2, wherein each said at least one remote module is further configured for reporting an operating status of the media channel.

4. The media gateway according to claim 3, wherein each said at least one remote module comprises:
a Time Division Multiplex (TDM) interface unit communicating with the PBX by a TDM interface;
an IP interface unit having an IP interface and configured for receiving and transmitting IP packets of the media stream;
a media-converting unit for converting the media stream between T1/E1 format and IP format;
a signaling gateway unit for converting format of one of the PBX signaling carried by the TDM interface unit and IP signaling from the center module;
a gateway-control agent unit for turning on and/or off the media channels under instructions from the center module; and
a maintenance-management agent unit for configuring parameters and/or reporting the operating status of the media channels under instructions from the central module.

5. The media gateway according to claim 3, wherein the center module comprises:
a gateway-control unit communicating with the MGC and configured for transforming control instructions of the MGC to commands instructing said at least one remote module to turn on and/or off the media channels of said at least one remote module;
an first IP interface unit at the remote module side for receiving and transmitting IP media stream from the remote modules;
an second IP interface unit at the network side for receiving and transmitting IP media stream from the network;
an IP forwarding unit for forwarding media stream between said first IP interface unit and said second IP interface unit and converting IP addresses and port numbers;
a signaling gateway aggregation unit for combining a plurality of signaling links of the remote modules into a combined signaling link to be sent to the MGC and demultiplexing a signaling link of the MGC into a plurality of signaling links to be sent to said at least one remote module; and
a maintenance-management unit for maintaining and managing the media gateway.

6. The media gateway according to claim 1, wherein said central module communicates with said at least one remote module via IP network.

7. A communication system comprising:
at least one private branch exchange (PBX);
a media gateway controller (MGC); and
a media gateway comprising:
at least one remote module, each disposed in proximity to one of said at least one PBX for converting format of a media stream and a signaling stream; and
a central module disposed in proximity to a packet switched network and communicating with said at least one remote module for transporting the media stream and the signaling stream in IP format between said at least one remote module and the packet switched network based on a control signaling from said MGC,
wherein said at least one PBX communicating with the packet switched network through said media gateway based on a control signaling from said MGC.

8. The communication system according to claim 6, wherein said central module is further configured for controlling said at least one remote module to turn on and off medial channels and configuring said at least one remote module.

9. The communication system according to claim 7, wherein each of said at least one remote module is further configured for reporting an operating status of the media channels.

10. The communication system according to claim 8, wherein each said at least one remote module comprises:
a Time Division Multiplex (TDM) interface unit communicating with said one of at least one PBX by a TDM interface;
an IP interface unit having an IP interface and configured for receiving and transmitting IP packets of the media stream;
a media-converting unit for converting the media stream between T1/E1 format and IP format;
a signaling gateway unit for converting format of PBX signaling carried by the TDM interface unit or IP signaling from the center module;
a gateway-control agent unit for turning on and/or off the media channels under instructions from the central module; and
a maintenance-management agent unit for configuring parameters and/or reporting the operating status of the media channels under instructions from the central module.

11. The communication system according to claim 8, wherein the central module comprises:
a gateway-control unit communicating with the MGC and configured for transforming control instructions of the MGC to commands instructing said at least one remote module to turn on and/or off the media channels of said at least one remote module;
an first IP interface unit at the remote module side for receiving and transmitting IP media stream from the remote modules;
a second IP interface unit at the network side for receiving and transmitting IP media stream from the network;
an IP forwarding unit for forwarding media stream between said first IP interface unit and said second IP interface unit and converting IP addresses and port numbers;
a signaling gateway aggregation unit for combining a plurality of signaling links of the remote modules into a combined signaling link to be sent to the MGC and demultiplexing a signaling link of the MGC into a plurality of signaling links to be sent to said at least one remote module; and
a maintenance-management unit for maintaining and managing the media gateway.

12. A media gateway comprising:
at least one remote module, each communicating with a private branch exchange (PBX) system; and
a central module communicating with entities in a packet switched network and said at least one remote module via the packet switched network;
wherein each said at least one remote module converts signals received from the PBX system in a format suitable for use in the packet switched network and converts signals received from said central module in a format suitable for use in the PBX system to allow the PBX system and the entities to interoperate, and said central module transports signals between said at least one remote module and the packed switched network entities based on instructions of a media gateway controller.

13. The media gateway according to claim 11, wherein each said at least one remote module further comprises a network interface for communicating with said central module via the packet switched network, and said central module further comprises a network interface for communicating with said at least one remote module via the packet switched network.

14. A media gate way according to claim 12, wherein each said at least one module transports a signaling stream and a media stream of signals.

15. The media gateway according to claim 13, wherein said central module combines signals received from the singling streams of more than one of said at least one remote module and generates a combined signal for transportation to the media gate controller.

16. The media gateway according to claim 14, wherein said central module extracts signals for one of said at least one remote module from an instruction signal received from the media gate controller and transports the signals to the singling stream of the remote module.

17. The media gateway according to claim 12, wherein said central module manages said at least one remote module, assigns each said at least one remote module an identifier for identification in the packet switched network, and detects an operating status of each said at least one remote module.

18. The media gateway according to claim 11, wherein said central module transforms a control signal from the media gate controller to commands instructing said at least one remote module to turn on and off media channels in the media stream for establishing call sessions.
